(19) United States
(12) Patent Application Publication
(10) Pub. No.: US 2006/0165126 A1
(43) Pub. Date: Jul. 27, 2006

(54) Bit rate controlling means in a telecommunication system

(76) Inventors: Justus Petersson, Stockholm (SE); Luigi D'Antonio, Rome (IT); Svetlana Chemiakina, Rome (IT); Per Beming, Stockholm (SE)

Correspondence Address: ERICSSON INC., 6300 LEGACY DRIVE, M/S EVR C11, PLANO, TX, 75024, US

(21) Appl. No.: 10/530,825

(22) PCT Filed: Jan. 13, 2003
(86) PCT No.: PCT/SE03/00026

§ 371 Date: Apr. 8, 2005

(30) Foreign Application Priority Data
Oct. 11, 2002 (SE) 0203056-7

(51) Int. Cl. H04J 3/18

(52) U.S. Cl. 370/477; 370/332

(57) ABSTRACT

The invention relates to a packet switched mobile telecommunication system, a rate controlling means in said system, a method and a computer program product. The system comprising at least a first rate controlling means residing in a Radio Controlling Entity, RCE, arranged for controlling bit rates of a first radio link to a first mobile terminal and a second rate controlling means arranged for controlling bit rates of a second radio link to a second mobile terminal. The first rate controlling means comprises means for notifying the second rate controlling means about a change of the bit rates of said first radio link, the first and the second rate controlling means comprise means for negotiating a corresponding change of the second radio link layer bit rate, and the first and the second rate controlling means comprise means for notifying their respective mobile terminals to modify their application layer bit rates accordingly.

### FIELD OF THE INVENTION

The present invention relates to an optimisation of the end-user Quality of Service (QoS) for Person-to-Person (P2P) packet switched services in a telecommunication systems, e.g. a 2.5G, a 3G and Wireless Local Area Networks (WLAN).

It relates in particular to a method and arrangements for network initiated bit rate control for P2P-services in a telecommunication system.

### BACKGROUND OF THE INVENTION

2.5G, 3G and WLAN mobile systems support different types of Packet Switched (PS) services. An example of a 2.5G system is a General Packet Radio Service (GPRS) system and an example of a 3G system is a Universal Mobile Telecommunication System (UMTS). A WLAN system provides fast wireless internet access. It is crucial for some applications that support for bit rate adaptation for the application layer is available. This is true, in particular when the application data is sent over a radio interface. The adaptation of the bit rate of the application is necessary when the bit rate of the radio link is modified.

In the radio access layer the offered capacity, e.g. the bandwidth, varies in time. Advanced radio network algorithms aim to reduce the risk that the system reaches an unstable point where the end-users' quality-of-service contract is broken and, at the same time, to maximise the offered quality-of-service for the end-user.

As PS systems work today, the radio access layer reacts quickly, whilst the application layer has a long latency before it accommodates to the new radio conditions. This mismatch between the radio access and the application layer implies lower capacity, in terms of the number of users, in the operators' network as well as degraded quality-of-service for the end-users.

Services may be divided into Person-To-Person (P2P)- and Person-To-Content (P2C)-services. An example of a packet switched P2P service is video plus speech conversational service. From the bit rate adaptation point of view the main difference is that in the P2P case both uplink and downlink may require an adaptation, while in the P2C case, only one of the links may require an adaptation. However, the transmitted traffic in the P2P case is often real time sensitive while in the P2C case the transmitted traffic usually has other requirements.

In one case of P2P-services, both end users are located in mobile systems. In this case the co-ordination between the entities controlling the radio interface is necessary, since the radio conditions are changing over time and the different radio interfaces are changing independently of each other.

In the application layer, there exist no mechanisms to quickly adapt to changed radio network conditions. The applications residing in the mobile terminals employ “poor” detection mechanisms for transmitting feedback information on the perceived quality-of-service to the originating source, e.g. the speaking party in a packet-switched conversational scenario.

Currently, the quality-of service of real time services are monitored by using the Real Time Control Protocol (RTCP) on top of the User Datagram Protocol (UDP). RTCP is a part of the Real Time Protocol (RTP) and is based on the periodic transmission of control packets to the participants in the session, using the same distribution mechanism as the data packets. The primary function of RTCP is to provide feedback on the quality of the data distribution, which moreover is an integral part of the RTP's role as a transport protocol. The 2 5 receiver of the user data transmits RTCP Receiver Reports, which contain an estimation of the received quality. The sender uses the received RTCP RRs for throughput estimation to detect a bit rate up or down-switch, i.e. an increase/reduction of the current radio link layer bit rate. The RTCP RRs are not allowed to be sent as often as may be required for a fast detection as the messages must not exploit more than 5% (2.5% UL and 2.5% DL) of the total session bandwidth, according to rules specified by the Internet Engineering Task Force (IETF) for the RTCP. For example in case of conversational service with two RTP flows, 12.2 kbps audio and 48 kbps video, every flow is controlled separately and the RRs are typically not allowed to be sent more often than once every two seconds for the audio stream and twice a second for the video stream. More than one RR is however necessary, for the sender, to perform a reliable throughput estimation.

In case of real time conversational services there are no application buffers that might compensate the adaptation delay. Thus, the packets that cannot be transmitted over the radio interface will be discarded. In case of down-switch from 64 to 32 kbps, this may lead to more than 50% packet losses during several seconds. The adaptation delay is particularly critical for P2P conversational services.

When using RTCP, there is no efficient way of detecting the radio link bit rate up-switch, and therefore increasing the available bandwidth. Thus, it is hard to use the RTCP RRs for detecting an increase of the available bandwidth, since the RR only contains an estimation of the received quality. Furthermore, channel probing strategy cannot be applied for real time services, as it requires that at least some data are buffered in advance, thus violating the delay requirement. Moreover, a “trial and error fashion” up-switch cannot be applied, as every erroneous up-switch would cause a long period of packet losses.

### SUMMARY OF THE INVENTION

Thus, there is a problem for packet switched Person to Person (P2P)-services in mobile networks to adapt the application layer bit rate to the radio link layer bit rate.

It is an object of the present invention to achieve a solution for the above mentioned problem.

The above mentioned object is achieved by means of a system according to claim 1, a method according to claim 9, a computer program product according to claim 17 and 18 and a rate controlling means according to claim 19.

The telecommunication system provided by the present invention comprising at least a first rate controlling means residing in a Radio Controlling Entity, RCE, arranged for controlling bit rates of a first radio link to a first mobile terminal, a second rate controlling means arranged for controlling bit rates of a second link to a second terminal, a first negotiating means and second negotiating means, wherein the first rate controlling means comprises means for notifying the second rate controlling means about a change of the bit rates of said first radio link, the first and the second negotiating means comprise means for negotiating a corresponding change of the second link layer bit rate, and the first and the second rate controlling means comprise means for notifying their respective mobile terminals to modify their application layer bit rates accordingly, makes it possible to adapt the application layer bit rate to the radio link layer bit rate.

The method provided by the present invention comprising the steps of notifying the second rate controlling means about a change of the bit rates of said first radio link, negotiating a corresponding change of the second link layer bit rate between a first and a second negotiating means, and notifying the first and second mobile terminals to modify their application layer bit rates accordingly, makes it possible to adapt the application layer bit rate to the radio link layer bit rate.

The rate controlling means residing in a Radio Controlling Entity, (RCE) provided by the present invention comprising means for controlling bit rates of a first radio link to a first mobile terminal, means for notifying a second rate controlling means controlling bit rates of a second radio link to a second mobile terminal about a change of the bit rates of said first radio link, means for receiving a result from a negotiation, between a first and second negotiating means, of a corresponding change of the second link layer bit rate, and means for notifying the first mobile terminal to modify its application layer bit rates accordingly, makes it possible to adapt the application layer bit rate to the radio link layer bit rate.

Preferred embodiments are set forth in the dependent claims.

An advantage with the present invention is that the rate control messages make use of the true assigned/employed bandwidth over the radio interface for a particular packet-switched session. This bandwidth information is retrieved directly from the radio access network, e.g. from the RNC, and facilitates hence an enhanced end-to-end quality-of-service for packet-switched conversational service.

Another advantage with the present invention is that the utilised information directly obtained from the Radio Access Network quickly balances the mismatch between the offered radio link layer bit rates with the application layer bit rates. That results in that fewer hardware units are required, e.g. buffers.

A further advantage with the present invention is that the bit rate adaptation over the radio link when controlled by two different radio control entities is co-ordinated. That makes it thus possible to avoid overload or waste of resources, i.e. bandwidth, over one of the radio links.

A further advantage with the present invention is that it provides the possibility for the network operator to control and optimise the quality-of-service.

A further advantage with the present is that it is applicable for all types of adaptive bit rate packet switched P2P services between two terminals, wherein at least one of the two terminals is located in a mobile communication network, and for any packet switched mobile system.

### BRIEF DESCRIPTION OF THE DRAWINGS

For a better understanding, references are made to the following drawings and preferred embodiments of the invention.

FIG. 1 shows an exemplary mobile telecommunication system where the present invention may be implemented.

FIG. 2 shows an example of a P2P-bit rate adaptation in a UMTS-system according to the present invention.

FIG. 3 shows an example of a P2P-bit rate adaptation in a UMTS-system with an intermediate node according to the present invention.

FIG. 4 shows a flowchart of the method according to the present invention.

FIG. 5 shows a signalling diagram of the rate control adaptation according to the present invention.

FIG. 6 shows a signalling diagram of the rate control adaptation according to the present invention where the negotiating means are located in an intermediate node.

### DETAILED DESCRIPTION

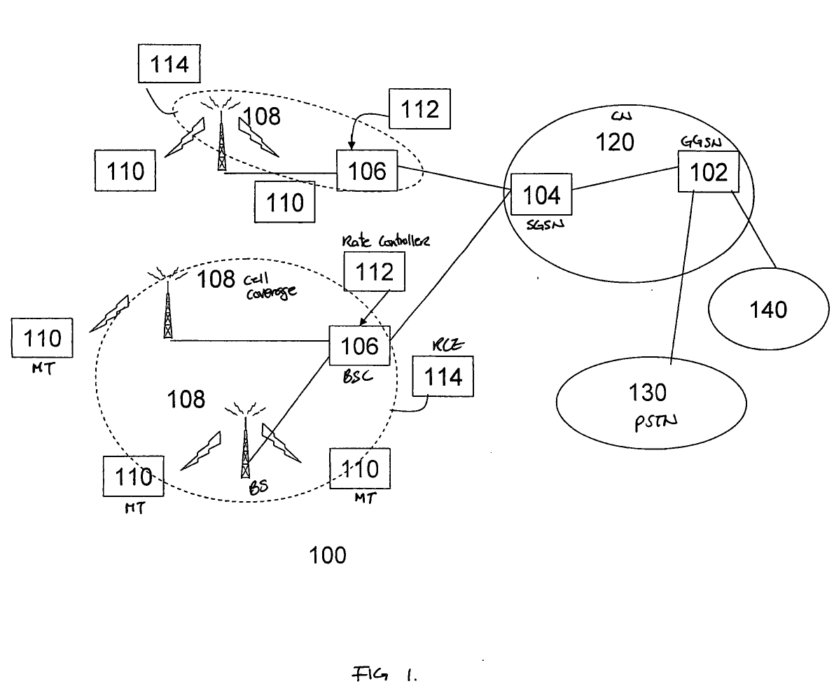

FIG. 1 shows an example of a packet switched mobile telecommunication system 100 wherein the present invention may be implemented. A GPRS system is used to illustrate said system. The system 100 comprises a first Core Network (CN) 120 comprising at least one Gateway GPRS Support Node (GGSN) 102 connected to at least one Serving GPRS Support Node (SGSN) 104. The first CN is connectable to other networks 130,140, such as the PSTN or another mobile network, by means of the GGSN. The SGSN 104 is connectable to a plurality of Radio Controlling Entities (RCE) 114. Each RCE 114 comprises a Base Station Controller (BSC) 106 and at least one Base Station (BS) 108 connected to the BSC 106. The BSCs control their connected Base Stations (BS) 108 and the BSs comprise means for wireless communication with a plurality of mobile terminals 110 located in the coverage of the respective BS 108. At least two RCEs 114 comprise rate controlling means 112 for controlling the bit rate of its radio link layer.

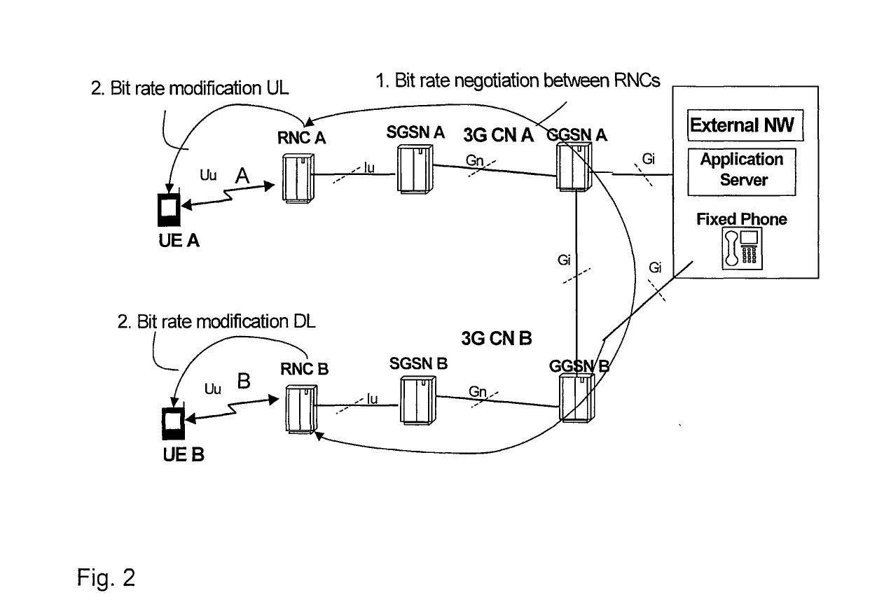

FIG. 2 shows an example of a person-to-person (P2P) bit rate adaptation in a UMTS-system in accordance with the present invention. The UMTS-system shown in FIG. 2 comprises two core networks, CNA, CNB. Each core network CNA, CNB comprises a Gateway GPRS Support Node (GGSN) connected to a Serving GPRS Support Node (SGSN). The GGSN may be connected to a plurality of SGSNs. The GGSN is a gateway towards external networks such as PSTNs or other mobile networks and the SGSN is connected to at least one Radio Controlling Entity (RCE) (not shown in FIG. 2). I.e. each RCE comprises a Radio Network Controller (RNC) and at least one base station (not shown in FIG. 2) connected to the RNC in the UMTS network. Each base station provides wireless communication with mobile terminals UE A, UE B. At least one RCE comprises rate controlling means for controlling the bit rate of its radio link Uu.

Referring to FIGS. 1 and 2, said rate controlling means is preferably a part of the Radio Resource Management (RRM). Said rate controlling means comprises, in one embodiment of the present invention a negotiating means. The negotiating means is arranged to perform a negotiation of radio link layer bit rates between two rate controlling means.

When an uplink and/or a downlink application layer bit rate over a radio link A requires a modification due to changed conditions on said radio link, a first rate controlling means of the radio link A transmits modification information to a second rate controlling means of a second radio link B. A proposed application layer bit rate modification is then negotiated between the second and the first rate controlling means by the negotiating means. The negotiating means is arranged to communicate the outcome of said negotiation to at least one of the rate controlling means. Then, the respective mobile terminals UE A, UE B are requested from the respective rate controlling means to adapt their sending application layer bit rates, and/or receiving application layer bit rates, accordingly. The respective rate controlling means transmits a radio message to their connected terminals by using a radio communication protocol, e.g. the Radio Resource Control (RRC) protocol to request the mobile terminals to adapt to the new application layer bit rate. Thus, the radio message is mapped to the application layer in order to perform the negotiated change of the application layer bit rate.

Hence, the first rate controlling means resides in the first RCE, while the second rate controlling means resides in one of the following locations:
a) in the same RCE as the first rate controlling means,
b) in a RCE different from the RCE of the first rate controlling means.
c) within another network, such as a fixed network.

In case a), since the first and second rate controlling means are located within the same RCE, the communication and negotiation between the two rate controlling means are fast and straightforward. Further explanation is superfluous.

In case b), the first and second rate controlling means communicate via intermediate nodes and/or gateways, such as GPRS support nodes. One example of case c) is illustrated in FIG. 2. It is described below, by way of an example with a UMTS network as shown in FIG. 2, how the communication between the first and second rate controlling means may be enabled.

In accordance with the present invention, a first RCE RNC A uses an IP address of a second mobile terminal UE B to send a rate control message to a second RCE RNC B. The first RCE RNC A sends a rate control message comprising the IP address of the second mobile terminal UE B. This IP address is used by intermediate nodes, e.g. the GGSN, in order to route the message to the second RCE, RNC B, which intercepts it.

The IP address of the second mobile terminal UE B is notified to the first RCE RNC A by the first mobile terminal UE A, e.g., during the service set-up in accordance with one embodiment of the present invention. The first mobile terminal UE A passes the IP address of the second mobile terminal UE B to the first RCE RNC A during the rate control service set-up. The IP address of the second mobile terminal UE B is known to the first mobile terminal UE A by means of initial application signalling, e.g. SDP.

In another embodiment of the present invention, the first RCE RNC A retrieves the IP address of the second mobile terminal UE B by “sniffing”, i.e. reading, the user data flow, in particular the IP/UDP header, during a session. Moreover the RCEs need to be notified whether the connection requires the bit rate notification service, which is further described below.

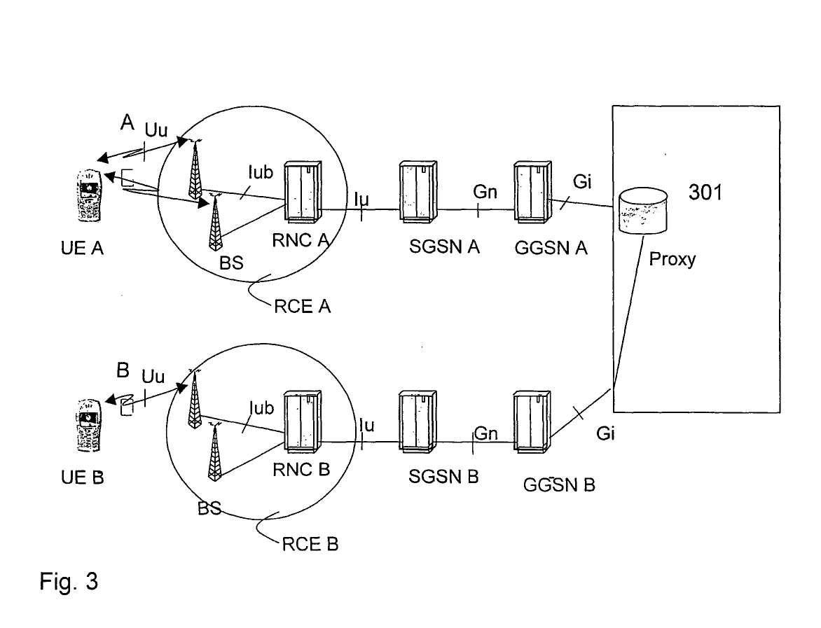

In one embodiment of the present invention which is further explained below, the negotiating means is located in an intermediate node, denoted proxy in FIG. 3. The intermediate node 301, may be located in a gateway or CN, Service Network, which is a network outside a CN. Although the intermediate node is shown in the figure, the node is not essential to the invention.

Thus, the negotiating means resides either in a rate controlling means or in an intermediate node, also denoted proxy as shown in FIG. 3. The system illustrated in FIG. 3 is a UMTS as illustrated in FIG. 2, but the messages that are sent between the two core networks, i.e. between the GGSNs GGSN A, GGSN B, pass through the intermediate node. The intermediate node comprises means for sniffing the data flow and intercepts messages based on different parameters, e.g. IP-address, port number or other identities. The negotiating mean in the intermediate node is arranged to communicate with rate controlling means in the core networks that are connected to the node.

An advantage with having the negotiating means in the intermediate node is that the rate control services may be initiated by said node instead of the mobile terminal. That implies that it is not necessary to introduce new functionality in the mobile terminals at introduction of the present invention in a network.

Two examples below describe how the rate adaptation in accordance with the present invention may be initialised in a UMTS network.

In the example illustrated in FIG. 2, a first rate controlling means is located in a first RCE RNC A and a second rate controlling means is located in a second RCE RNC B, wherein both the first and second rate controlling means comprise negotiating means. Thus, it should be understood by the person skilled in the art that it is the rate controlling means within the respective RCE that performs the rate adaptation related functions described below.

A first User Equipment (UE) A, also referred to as mobile terminal starts the session by sending a message to a second UE B. This message contains e.g. a Session Description Protocol (SDP) file, which describes the characteristics of the UE A. The file comprises a set of rate control service parameters, e.g. a rate control identity, port number, IP-address and an attribute indicating that the UE A supports the Rate Control adaptation service in accordance with the present invention. In the UMTS, the rate control identity may be used as binding information in the RNC between a Radio Access Bearer (RAB) on the radio link layer and the application session for which the rate control service is employed. The attribute may be utilised by the UE B in order to indicate for the second RCE RNC B that the UE A is attached to the radio access network supporting said Rate Control adaptation service. Moreover, the SDP file contains an attribute, which indicates the bit rates supported by the UE A. The UE B replies with message containing its SDP file with the same information.

Once the UE A and the UE B know the session characteristics of each other they start the PDP context activation procedure in e.g. in accordance with the 3GPP specification 23.060. The Activate PDP context message from the UE A comprises the rate control service parameters of the UE B. This information is forwarded to the first RCE RNC A by the SGSN SGSN A, that the first RCE is connected to.

When the first RCE RNC A receives the message containing the rate control service parameters it understands that the initial bit rate must be negotiated with the second RCE RNC B. The first RCE RNC A uses the IP address of UE B contained in the rate control service parameters to route the message to the second RCE RNC B. The message contains the available bit rates over radio link A.

After the initial bit rate is negotiated between the negotiating means in RCEs, the UE A and the UE B are notified about the allowed initial bit rate by the RCEs over the radio interfaces.

In the example illustrated in FIG. 3, a first rate controlling means is located in a first RCE RNC A and a second rate controlling means is located in a second RCE RNC B, while the negotiating means for the first and second rate controlling means are located in an intermediate node 301. By using the intermediate node, the User Equipment (UE), also referred to as mobile terminal, is not required to be aware of the rate control adaptation service in accordance with the present invention, since the service is initiated by the intermediate node.

The UE A starts a packet switched conversational session by sending a message, to the UE B. via the intermediate node, denoted proxy in FIG. 3. This message contains among other things the SDP file, which indicates applicable application layer bit rates for the session.

Thereafter, the UE A sends an acknowledgement to the UE B, via the intermediate node. Said node issues the Rate Control service in accordance with the present invention after intercepting the acknowledgement. The intermediate node is arranged to initiate the first and second RCE for the current session by sending a rate control message comprising the rate control service parameters according to the present invention. The rate control identity of said parameters is needed as binding information in the first RCE, in order for the RCE to be able to send the Rate Control messages according to the present invention for the specific session. It sends the message based on the IP address and the port number of the rate control parameters.

Two further examples below describe how the rate adaptation in accordance with the present invention may be performed in a UMTS network.

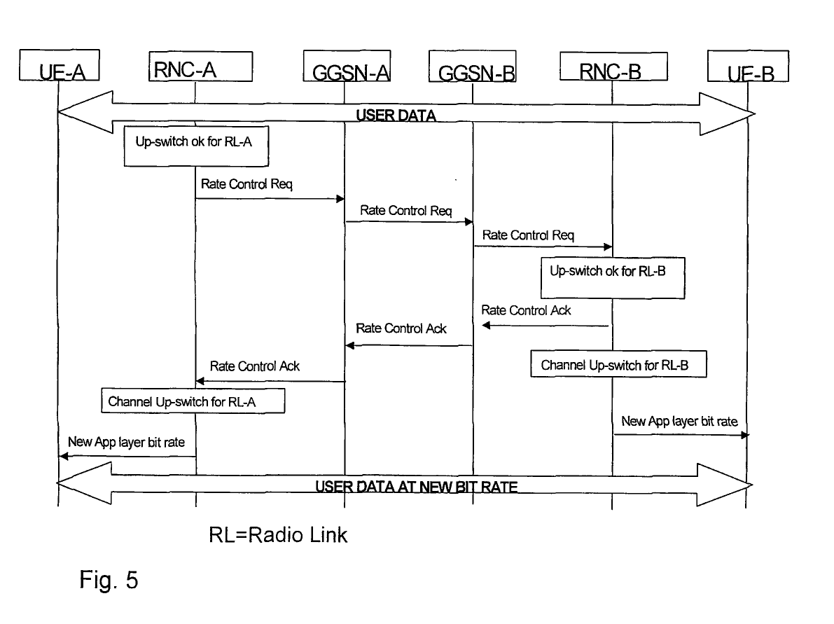

The first example illustrates the rate adaptation in a network in accordance with the FIG. 2, i.e. the rate controlling means comprises the negotiating means. This is shown in the signalling diagram of FIG. 5.

When the bit rate over the radio link A is modified, e.g. additional resources are available (i.e. up-switch), the first RCE RNC A sends a control message to the second RCE RNC B. If it is possible to perform the required bit rate modification the second RCE RNC B replies with an ACK message and switches its radio link layer bit rate. Otherwise the second RCE RNC B may propose an alternative bit rate value, i.e. the negotiating means in the first and second RCE performs a bit rate negotiation. After the reception of ACK message or after a timeout the RCEs RNC A, RNC B switch the radio link layer bit rates. The RCEs inform the UEs about the radio bit rate modification by means of radio messages. The radio message such as a RRC message is mapped onto the application layer and the UEs adapt the application layer bit rate accordingly.

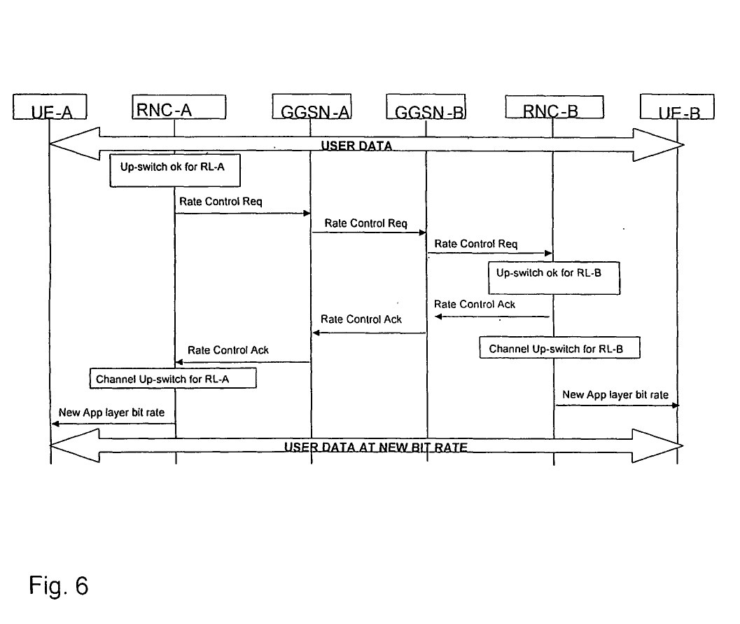

In the example illustrated in the FIG. 3, the negotiating means of the first and second rate controlling means are located in an intermediate node, denoted proxy. An example of the rate adaptation procedure is shown in the signalling diagram of FIG. 6.

When the bit rate over the radio link A requires the modification, e.g. additional resources are available (i.e. up-switch), the first RNC A sends a rate control message comprising the rate control service parameters to the second RNC B.

The control message is intercepted in the intermediate node by means of the rate control identity. The negotiating means in the intermediate node matches the available resources for the radio links A and B respectively. In case of an up-switch the negotiating means in the intermediate node is required to check with the second rate controlling means in the second RCE RNC B if a proposed up-switch is allowed. The negotiating means in the intermediate node issues Rate Control commands to the RCEs.

After the reception of the Rate Control command in accordance with the present invention from the intermediate node, the RCEs switch the radio link layer bit rates accordingly. The RCEs inform the UEs about the radio bit rate modification by means of a message over the radio interface. The message is mapped onto application layer and the UEs adapt the application layer bit rate accordingly.

In the case of down-switch, i.e. the resources over the radio link A is decreased, the negotiating means in the intermediate node may not be required to check with the second RCE RNC B before it determines the new rate. Also the message comprising the new rate from the first RCE RNC A to the UE A may be dropped since the bit rate over radio link A already is adjusted.

An advantage with the solution without an intermediate node is that it performs better due to decreased signalling latency. However, an architecture without an intermediate node has impacts on the mobile terminals UEs, since the rate adaptation service is initiated by the mobile terminal.

The following further describes an example of application layer bit rate adaptation due to changes of the radio link A in case of a UMTS packet-switched network, wherein reference is made to FIG. 2. It should however be noted that the example below also is applicable to other systems which implies that the RNC A and RNC B can be replaced with the general terms RCE A and RCE B and the UE A and UE B can be replaced with mobile terminal A and mobile terminal B. Moreover, as discussed above a RCE in a GPRS system is a node within the Base Station System (BSS) e.g. the Base Station Controller (BSC). In the example below it is assumed that the RNC A and RNC B are the RCEs and that they comprise rate controlling means including the negotiating means.

Regarding the downlink adaptation, when a RNC A modifies the downlink layer bit rate over a radio link A to a UE A, a UE B in connection with the UE A over a radio link B must adapt its sending rate, i.e. the bit rate modification must be negotiated with a RNC B, that comprises rate controlling means for the radio link B, and delivered to the UE B. The down-switch case is particularly time critical. When the channel bit rate is down-switched, the application layer bit rate of the sending party must be adapted as soon as possible in order to avoid packet losses. The RNC A sends the bit rate modification message to the RNC B, which replies with an acknowledgement (ACK) and switches the channel bit rate. The RNC B notifies the UE B, which modifies its sending rate accordingly. For the up-switch, the negotiation between the RNC A and RNC B is necessary in order to avoid the waste of resources over the radio link A in case that the bit rate over the radio link B cannot be up-switched. If the RNC A has additional resources in its downlink it notifies this to the RNC B. The RNC B checks if it is possible to switch up the uplink rate over the air interface B and replies with an acknowledgement or non-acknowledgement (ACK/NACK). In case of a acknowledgement the UE B is notified to switch up its radio link layer bit rate of radio link B and then to switch up its sending application layer bit rate.

The RCEs are aware of the permitted rates of their respective connected mobile terminals.

Regarding the uplink adaptation, when the RNC A modifies the uplink radio link layer bit rate, the UE A must adapt its application sending rate. In order to avoid a waste of radio resources over the radio link B such modification must be negotiated with the RNC B before the UE A is allowed to adjust its application layer bit rate in the up-switch case. In the down-switch case the UE A is allowed to reduce its application sending rate before the reduction is negotiated with the RNC B e.g. in the event of rapidly impairing radio conditions. The up- and down-switches are performed in the same way as described above for the downlink adaptation.

The bit rate adaptation service provided the present invention functions transparently between different types of networks, such as between a GPRS network and a UMTS network, between a UMTS network and a WLAN etc.

Furthermore, the method and arrangements according to the present invention are also applicable when one of the end-terminals is located in affixed network, such as PSTN. The rate controlling means for the fixed connection resides then in a node in the fixed network. It is also possible to use an intermediate node for the negotiating means in a fixed network.

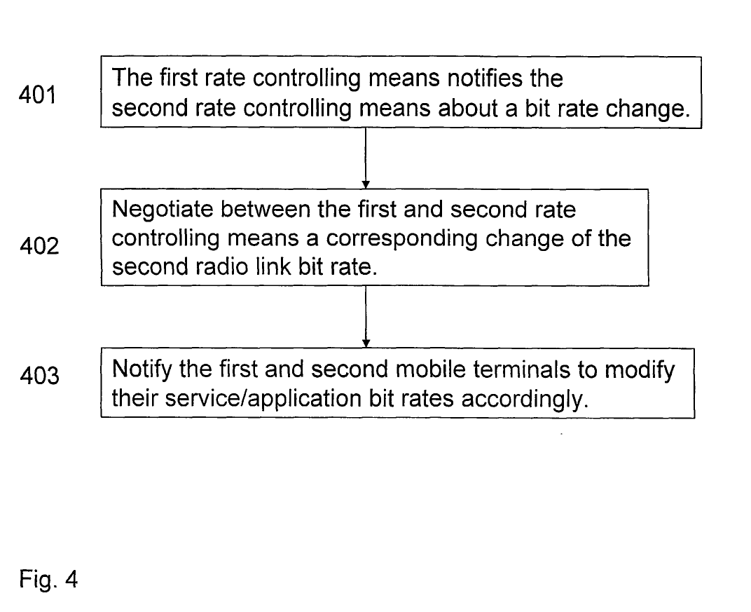

The method according to the present invention in a general mode is illustrated in the flowchart shown in FIG. 4. The method comprising the following steps:

401. The first rate controlling means notifies the second rate controlling means about a change of the bit rates of said first radio link.

402. Negotiate between a first and a second negotiating means a corresponding change of the second link layer bit rate.

403. Notify the first and second mobile terminals to modify their application layer bit rates accordingly.

Thus, said method according to the present invention provides a way to adapt the application layer bit rates to modifications of radio link layer bit rates which may occur due to changed radio conditions.

The method is implemented by means of a computer program product comprising the software code portions for performing the steps of the method. The computer program product is run on a computer stored in a RCE or in a RCE and an intermediate node within the packet switched radio communications system. The computer program is loaded directly or from a computer usable medium, such as a floppy disc, a CD, the Internet etc.

When implementing the present invention in existing mobile telecommunication systems existing software and/or hardware will have to be modified as will be understood by the person skilled in the art. In most cases the modifications will mainly be software modifications. The rate controlling means in the RCE must be adapted so that it can communicate notifications according to the present invention to another unit, such as another RCE, or an intermediate node comprising a rate controlling means.

The present invention is not limited to the above-described preferred embodiments. Various alternatives, modifications and equivalents may be used. Therefore, the above embodiments should not be taken as limiting the scope of the invention, which is defined by the appending claims.

1. Telecommunication system including a Radio Controlling Entity, a first mobile terminal and a second mobile terminal, comprising:
first rate controlling means residing in said Radio Controlling Entity for controlling bit rates of a first radio link to said first mobile terminal;
second rate controlling means arranged for controlling bit rates of a second radio link to said second mobile terminal;
wherein the first rate controlling means further comprises means for notifying the second rate controlling means about a change of the bit rates of said first radio link;
negotiating means for negotiating a corresponding change to the bit rate of the second radio link; and
the first and the second rate controlling means further comprise means for notifying their respective mobile terminals to modify their application layer bit rates in accordance with said negotiated bit rate.

2. System according to claim 1, wherein said second rate controlling means resides within the same radio Controlling Entity as the first radio controlling means.

3. System according to claim 1, wherein the first rate controlling means comprises the negotiating means and the second rate controlling means comprises the a second negotiating means.

4. System according to claim 1, wherein the negotiating means is located in an intermediate node within said telecommunication system.

5. System according to claim 1, wherein the first rate controlling means comprises means for notifying the second rate controlling means by means of any of the parameters IP-address, port number and/or rate control identity of the second terminal.

6. System according to claim 1, wherein the rate controlling means comprises means for sniffing an IP/UDP/TCP/HTTP header in a data flow.

7. System according to claim 1, wherein the first mobile terminal comprises means for passing any of the parameters IP address, port number and/or rate control identity of the second mobile terminal to the first rate controlling means during a service set-up.

8. System according to claim 1, wherein the telecommunication system comprises a Universal Mobile Telephony System, UMTS and/or a General Packet Radio Service (GPRS) System, and/or a WLAN system.

9. Method in a telecommunication system, including a first rate controlling means residing in a Radio Controlling Entity, for controlling bit rates of a first radio link to a first mobile terminal, a second rate controlling means for controlling bit rates of a second link to a second terminal, wherein said first rate controlling means is associated with a first negotiating means and said second rate controlling means is associated with a second negotiating means comprising the steps of:
detecting a change of the bit rates of said first radio link with said first mobile terminal;
notifying the second rate controlling means about said change of the bit rates of said first radio link,
negotiating a corresponding change of the bit rate of said second link between the first and second negotiating means, and
notifying the first mobile terminal and second terminal to modify their application layer bit rates in accordance with said negotiated bit rate.

10. Method according to claim 9, wherein said second rate controlling means resides within the same Radio Controlling Entity as the first radio controlling means.

11. Method according to claim 9, wherein the first rate controlling means comprises the first negotiating means and the second rate controlling means comprises the second negotiating means.

12. Method according to claim 9, wherein the step of negotiation is performed by an intermediate node.

13. Method according to claim 9, wherein the step of notifying said second rate controlling means is performed by means of any of the parameters IP-address, port number and/or rate control identity of the second terminal.

14. Method according to claim 13, further comprising the step of:
sniffing an IP/UDP/TCP/HTTP header in a data flow in order to obtain any of the parameters the IP-address, port number and/or rate control identity of the second terminal.

15. Method according to claim 13, comprising further step of:
passing any of the parameters IP address, port number and/or rate control identity of the second terminal to the first rate controlling means during a service set up set-up.

16. Method according to claim 9, wherein the telecommunication system comprises a Universal Mobile Telephony System, UMTS and/or a General Packet Radio Service (GPRS) System, and/or a WLAN system.

17-18. (canceled)

19. A rate controlling means residing in a Radio Controlling Entity in a telecommunication system including a first mobile terminal and a second mobile terminal comprising:
means for controlling bit rates of a first radio link to said first mobile terminal, said rate controlling means further comprises means for notifying a second rate controlling means controlling bit rates of a second radio link to said second mobile terminal in response to a change of the bit rates of said first radio link;
a first and second negotiating means for negotiating a corresponding change of the bit rate of said second radio link for said second mobile terminal;
means for receiving a result from said negotiation means; and
means for notifying the first mobile terminal to modify its application layer bit rates in accordance with said negotiated bit rate.

20. A rate controlling means according to claim 19, wherein said first negotiating means is located in the rate controlling means.

21. A rate controlling means according to claim 19 wherein said means for notifying said second rate controlling means uses any of the parameter IP address, port number and/or rate control identity of the second mobile terminal.

22. A rate controlling means according to claim 19 further comprises means for sniffing an IP/UDP/TCP/HTTP header in a data flow.
